(19) United States
(12) Patent Application Publication
(10) Pub. No.: US 2011/0316347 A1
(43) Pub. Date: Dec. 29, 2011

(54) WIRELESS POWER RECEIVING APPARATUS

(75) Inventors: Yuki Endo, Tokyo (JP); Yasuo Furukawa, Tokyo (JP)

(73) Assignee: ADVANTEST CORPORATION, Tokyo (JP)

(21) Appl. No.: 13/159,272

(22) Filed: Jun. 13, 2011

Related U.S. Application Data
(60) Provisional application No. 61/358,307, filed on Jun. 24, 2010.

(51) Int. Cl. H01F 38/14

(52) U.S. Cl. 307/104

(57) ABSTRACT

A wireless power receiving apparatus receives an electric power signal including any one of an electric field, magnetic field, or electromagnetic field, transmitted from a wireless power supply apparatus. A resonance capacitor is arranged together with a reception coil to form a resonance circuit. A switch is provided in order to switch the state between a first state in which the load circuit is connected in series with the resonance circuit including the reception coil and the resonance capacitor and a second state in which the load circuit is disconnected from the resonance circuit. A control unit controls the switch so as to alternately switch the state between the first state and the second state in a time sharing manner.

### BACKGROUND OF THE INVENTION

1. Field of the Invention

The present invention relates to a wireless power supply technique.

2. Description of the Related Art

In recent years, wireless (contactless) power transmission has been receiving attention as a power supply technique for electronic devices such as cellular phone terminals, laptop computers, etc., or for electric vehicles. Wireless power supply transmission can be classified into three principal methods: an electromagnetic induction method, an electromagnetic wave reception method, and an electric field/magnetic field resonance method.

The electromagnetic induction method is employed to supply electric power at a short range (several cm or less), which enables electric power of several hundred watts to be transmitted in a band that is equal to or lower than several hundred kHz. The power use efficiency thereof is on the order of 60% to 98%.

In a case in which electric power is to be supplied over a relatively long range of several meters or more, the electromagnetic wave reception method is employed. The electromagnetic wave reception method allows electric power of several watts or less to be transmitted in a band between medium waves and microwaves. However, the power use efficiency thereof is small. The electric field/magnetic field resonance method has been receiving attention as a method for supplying electric power with relatively high efficiency at a middle range on the order of several meters (see Non-patent document 1).

### RELATED ART DOCUMENTS

### Patent Documents

### Non-Patent Document 1

A. Karalis, J. D. Joannopoulos, M. Soljacic, “Efficient wireless non-radiative mid-range energy transfer” ANNALS of PHYSICS Vol. 323, January 2008, pp. 34-48.

The Q value can be offered as an example of an important parameter for such magnetic field (electric field) resonance electric power transmission. FIG. 1 is a diagram which shows an example of a wireless power supply system. A wireless power supply system 1100 includes a wireless power supply apparatus 1200 and a wireless power receiving apparatus 1300.

The wireless power supply apparatus 1200 includes a transmission coil L1, a resonance capacitor C1, and an AC power supply 10. The AC power supply 10 generates an electric signal S2 having a transmission frequency f₁. The resonance capacitor C1 and the transmission coil L1 form a resonance circuit. The resonance frequency of the resonance circuit thus formed is tuned to be the same as that of the electric signal S2. An electric power signal S1 is transmitted from the transmission coil L1.

The wireless power receiving apparatus 1300 includes a reception coil L2, a resonance capacitor C2, and a load circuit 20. The resonance capacitor C2, the reception coil L2, and the load circuit 20, form a resonance circuit. The resonance frequency of the resonance circuit thus formed is tuned to be the same as that of the electric power signal S1.

With such a wireless power supply system 1100, with a higher Q value, the electric power can be transmitted over a long distance with higher efficiency. Assuming that the load circuit 20 includes a path having a resistance component R2 connected in series with the resonance capacitor C2 and the reception coil L2, the Q value of the resonance circuit is represented by Q=2πf₁·L/R. Accordingly, as the resistance value R becomes higher, the Q value becomes lower.

That is to say, with a system in which the load circuit 20 is connected to the reception antenna via the rectifier circuit and the power storage capacitor, the load circuit 20 is regarded as being AC shorted via the power storage capacitor. Accordingly, the load circuit 20 does not substantially affect the Q value.

However, with an arrangement in which the load circuit 20 is directly connected to the reception antenna, the Q value is immensely reduced. In some cases, this leads to a problem of reduced electric power transmission efficiency.

### SUMMARY OF THE INVENTION

The present invention has been made in order to solve such a problem. Accordingly, it is an exemplary purpose of an embodiment of the present invention to improve the electric power transmission efficiency.

An embodiment of the present invention relates to a wireless power receiving apparatus configured to receive an electric power signal including any one of an electric field, magnetic field, or electromagnetic field, transmitted from a wireless power supply apparatus. The wireless power receiving apparatus comprises: a reception coil configured to receive the electric power signal; a resonance capacitor arranged together with the reception coil to form a resonance circuit; and a load circuit. The wireless power receiving apparatus further comprises: a switch configured to switch the state between a first state in which the load circuit is connected in series with the resonance circuit comprising the reception coil and the resonance capacitor and a second state in which the load circuit is disconnected from the resonance circuit; and a control unit configured to control the switch so as to alternately switch the state between the first state and the second state in a time sharing manner.

In the second state, the load circuit is disconnected from the resonance circuit, thereby increasing the Q value. The increase in the Q value raises the level of the resonance state, thereby raising the efficiency of power transmission from the power supply apparatus. The energy stored in the second state is stored in the reception coil and the resonance capacitor. After being switched to the first state, the elevated resonance state level is maintained for a certain period, thereby allowing electric power to be received with the elevated Q value. Subsequently, the resonance state level drops over time, and drops to the previous low value. By repeatedly performing such an operation, such an arrangement provides high-efficiency electric power transmission.

Also, the time ratio of the first state may be 70% or less of the period of the overall switching operation.

Also, the time ratio of the first state may be 50% or less of the period of the overall switching operation.

Another embodiment of the present invention also relates to a wireless power receiving apparatus configured to receive an electric power signal including any one of an electric field, magnetic field, or electromagnetic field, transmitted from a wireless power supply apparatus. The wireless power receiving apparatus comprises: a reception coil configured to receive the electric power signal; a resonance capacitor arranged together with the reception coil to form a resonance circuit; a load circuit; a first diode arranged on a loop that comprises the reception coil and the resonance capacitor; and a second diode arranged between the cathode of the first diode and the load such that the cathode is arranged on the load side.

With such an embodiment, the Q value of the circuit is raised by means of a half-wave rectifier circuit that comprises the first diode and the second diode. Thus, such an arrangement provides high-efficiency electric power transmission.

Yet another embodiment of the present invention relates to a wireless power supply system. The wireless power supply system comprises: a wireless power supply apparatus configured to transmit an electric power signal including any one of an electric field, magnetic field, or electromagnetic field; and the aforementioned wireless power receiving apparatus configured to receive the electric power signal.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows an example of a wireless power supply system;

FIG. 2 is a circuit diagram which shows a configuration of a wireless power supply system according to a first embodiment;

FIG. 3 is a waveform diagram which shows the operation of the wireless power supply system shown in FIG. 2;

FIG. 4 is a circuit diagram used in a simulation of the operation of the wireless power supply system shown in FIG. 2;

FIG. 5 is a graph showing the relation between the transmitted electric power, the received electric power, and the transmission efficiency, with respect to the duty ratio; and

FIG. 6 is a circuit diagram which shows a configuration of a wireless power supply system according to a second embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

### First Embodiment

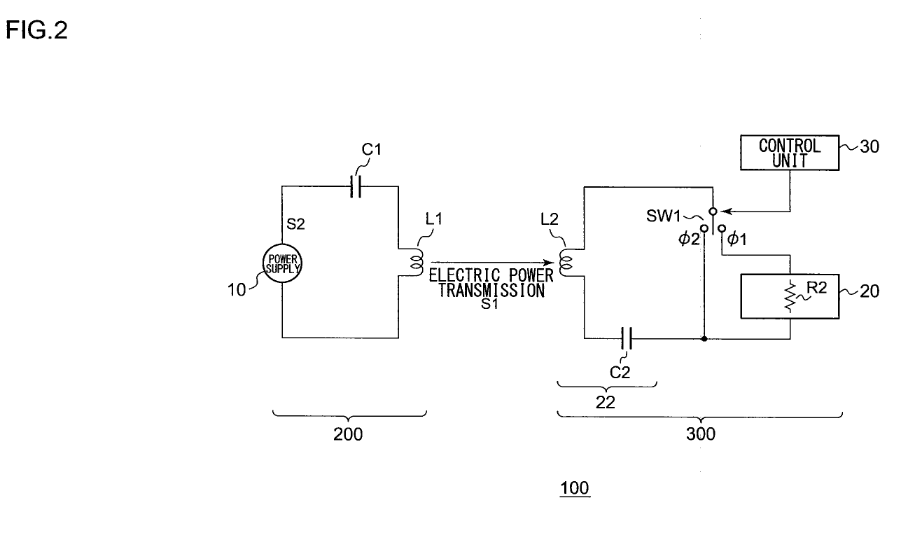

FIG. 2 is a circuit diagram which shows a configuration of a wireless power supply system 100 according to a first embodiment. The wireless power supply system 100 includes a wireless power supply apparatus 200 and a wireless power receiving apparatus 300.

The wireless power supply apparatus 200 transmits an electric power signal S1 to the wireless power receiving apparatus 300. As such an electric power signal S1, the wireless power supply system 100 uses the near-field component (electric field, magnetic field, or electromagnetic field) of electromagnetic waves that has not become radio waves.

The wireless power supply apparatus 200 includes an AC power supply 10, a transmission coil L1, and a resonance capacitor C1. The AC power supply 10 generates an electric signal S2 having a predetermined frequency, or subjected to frequency-modulation, phase-modulation, amplitude-modulation, or the like. For simplicity of description and ease of understanding, description will be made in the present embodiment regarding an arrangement in which the electric signal S2 is an AC signal having a constant frequency. For example, the frequency f₁ of the electric signal S2 is selected from a range between several hundred KHz and several MHz.

The transmission coil L1 is an antenna configured to emit the electric signal S2 generated by the AC power supply 10, as a near-field signal (electric power signal) S1 including any one of an electric field, magnetic field, or electromagnetic field. The resonance capacitor C1 is arranged in series with the transmission coil L1, and is configured to tune the common frequency to be the same as the transmission frequency f₁.

The above is the configuration of the wireless power supply apparatus 200. Next, description will be made regarding the configuration of the wireless power receiving apparatus 300. The wireless power receiving apparatus 300 receives the electric power signal S1 transmitted from the wireless power supply apparatus 200. The wireless power receiving apparatus 300 includes a reception coil L2, a resonance capacitor C2, a load circuit 20, a switch SW1, and a control unit 30.

The resonance capacitor C2 is arranged together with the reception coil L2 to form a resonance circuit 22.

The reception coil L2 receives the electric power signal S1 from the transmission coil L1. An induced current (resonant current) I_{COIL} that corresponds to the electric power signal S1 flows through the reception coil L2. The wireless power receiving apparatus 300 acquires electric power via the induced current thus generated.

The load circuit 20 is a circuit configured to operate receiving electric power supplied from the wireless power supply apparatus 200. Its usage and configuration are not restricted in particular. The resistance component in the load circuit 20 will be represented by R2.

The wireless power receiving apparatus 300 is configured to be switchable between a first state φ₁ and a second state φ₂. In the first state φ₁, the load circuit 20 is connected in series to the resonance circuit 22 including the reception coil L2 and the resonance capacitor C2. In the second state φ₂, the load circuit 20 is disconnected from the resonance circuit 22.

The switch SW1 is arranged in order to switch the state between the first state φ₁ and the second state φ₂. FIG. 2 shows the switch SW1 configured as a two-to-one switch. Also, such an arrangement may include two switches each configured as a one-to-one switch. Alternatively, other configurations may be made. When the switch SW1 activates a path to the resonance capacitor C2 side, the state is switched to the first state φ₁, and when the switch SW1 activate a path to the load circuit 20 side, the state is switched to the second state φ₂.

The control unit 30 controls the switch SW1 so as to alternately switch the state between the first state φ₁ and the second state φ₂ in a time sharing manner. The frequency of the switching operation is set to be lower than the transmission frequency f₁ of the electric power signal S1.

The above is the configuration of the wireless power supply system 100. Next, description will be made regarding the operation thereof.

The efficiency of transmission between the wireless power supply apparatus 200 and the wireless power receiving apparatus 300 is determined by a number of factors, examples of which include the coupling coefficient between the transmission coil L1 and the reception coil L2 and the Q value of the wireless power receiving apparatus 300 side. That is to say, improving the Q value contributes to improving the transmission efficiency.

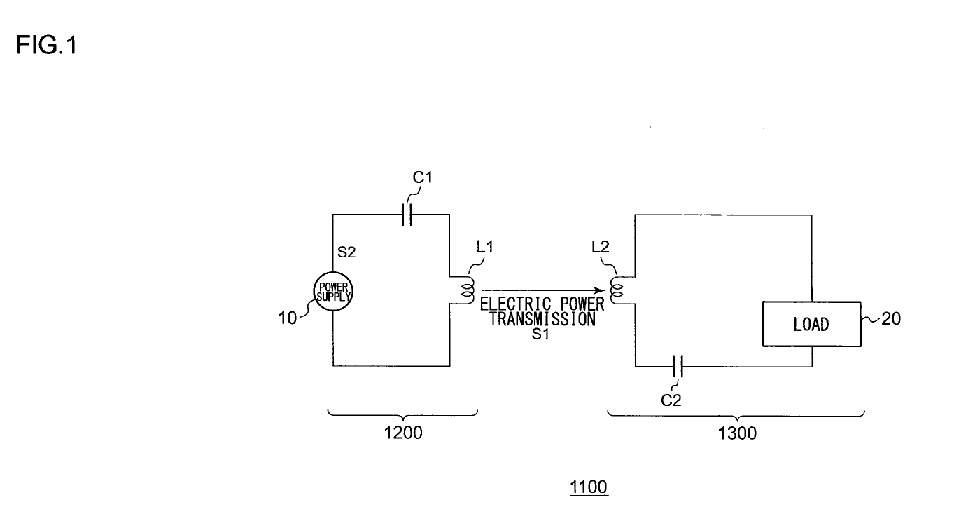

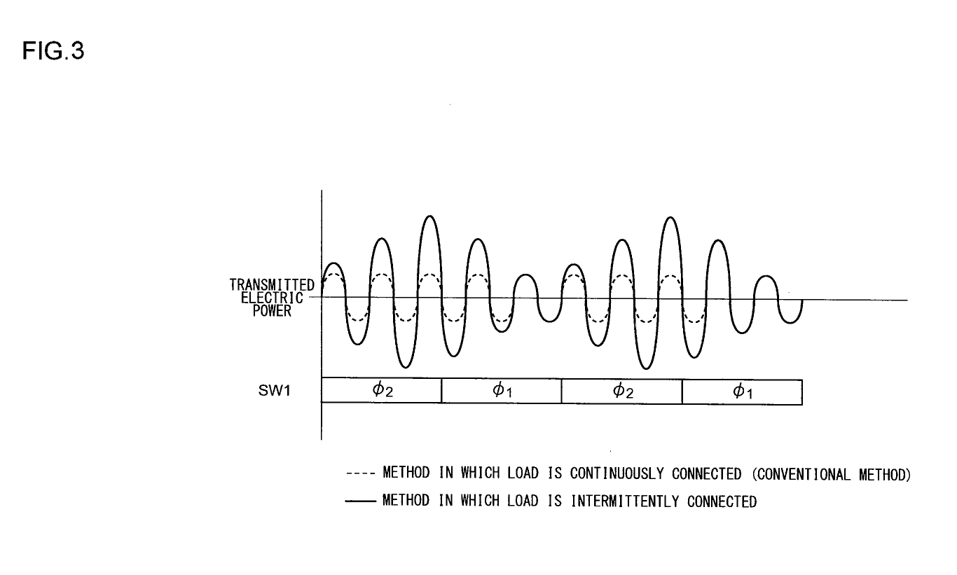

FIG. 3 is a waveform diagram showing the operation of the wireless power supply system 100 shown in FIG. 2. It should be noted that the vertical axis and the horizontal axis in FIG. 3 are expanded or reduced as appropriate for ease of understanding. Also, each waveform shown in the drawing is simplified for ease of understanding. In order to further clarify the advantages of the wireless power supply system 100 according to the present embodiment, first, description will be made regarding the operation of an arrangement according to a comparison technique shown in FIG. 1.

In FIG. 3, the broken line represents the operation of the wireless power supply system shown in FIG. 1. The operation of the wireless power supply system shown in FIG. 1 is equivalent to the operation of the wireless power supply system 100 shown in FIG. 2 when it is fixed at the first state φ₁. As described above, the load resistor R2 is connected in series with the reception coil L2 and the resonance capacitor C2, which reduces the Q value. This results in the transmitted electric power having a low, constant level.

Next, description will be made regarding the operation of the wireless power supply system 100 shown in FIG. 2 with reference to the solid line in FIG. 3. As described above, such an arrangement alternately switches the state between the first state φ₁ and the second state φ₂ in a time sharing manner. FIG. 3 shows a case in which the duty ratio of the switching operation is 50%.

In the second state φ₂, the load circuit 20 is disconnected from the resonance circuit 22, thereby increasing the Q value. Due to the increased Q value, the level of the resonance state is raised, thereby raising the efficiency of transmission from the wireless power supply apparatus 200. The energy supplied in the second state φ₂ is stored in the reception coil L2 and the resonance capacitor C2.

After the state is switched to the first state φ₁ the elevated resonance state level is maintained for a certain period, thus allowing electric power to be received with an improved Q value during this period. Subsequently, the resonance state level decreases over time, and drops to the previous low level.

With the wireless power supply system 100 shown in FIG. 2, by alternately switching the sate between the first state φ₁ and the second state φ₂, such an arrangement provides high-efficiency electric power transmission.

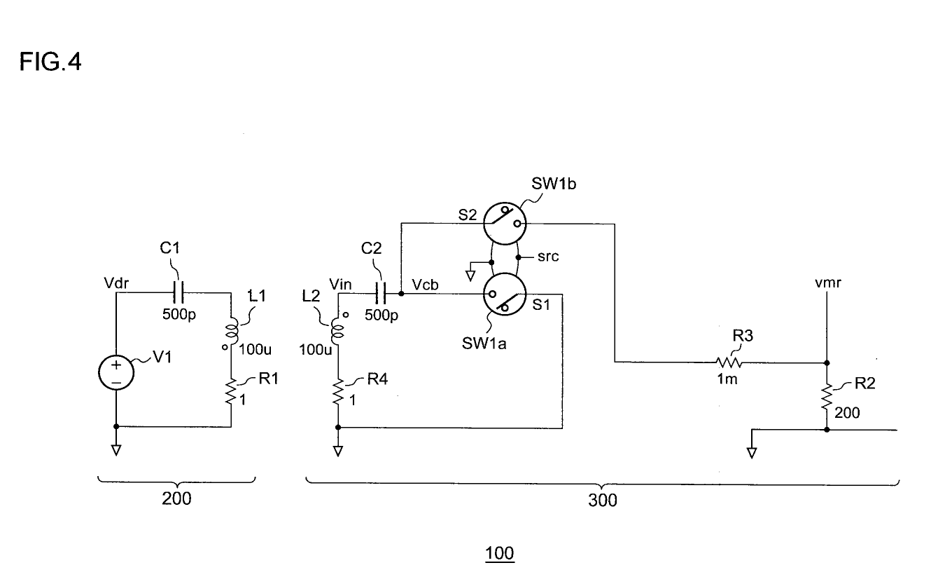

With the wireless power supply system 100 shown in FIG. 2, the transmission efficiency and the supplied electric power are changed according to the time ratio (duty ratio) between the first state φ₁ and the second state φ₂. FIG. 4 is a circuit diagram used in a simulation of the operation of the wireless power supply system 100 shown in FIG. 2. In FIG. 4, the switch SW1 is represented as a pair of switches SW1a and SW1b each configured as a one-to-one switch. It should be noted that the resistors R1 through R3 each represent a parasitic resistance. The resistance value, the capacitance value, and the inductance value of each circuit element are indicated in the vicinity of the respective circuit elements. Description will be made assuming that the coupling level K between the transmission coil L1 and the reception coil L2 is 0.005.

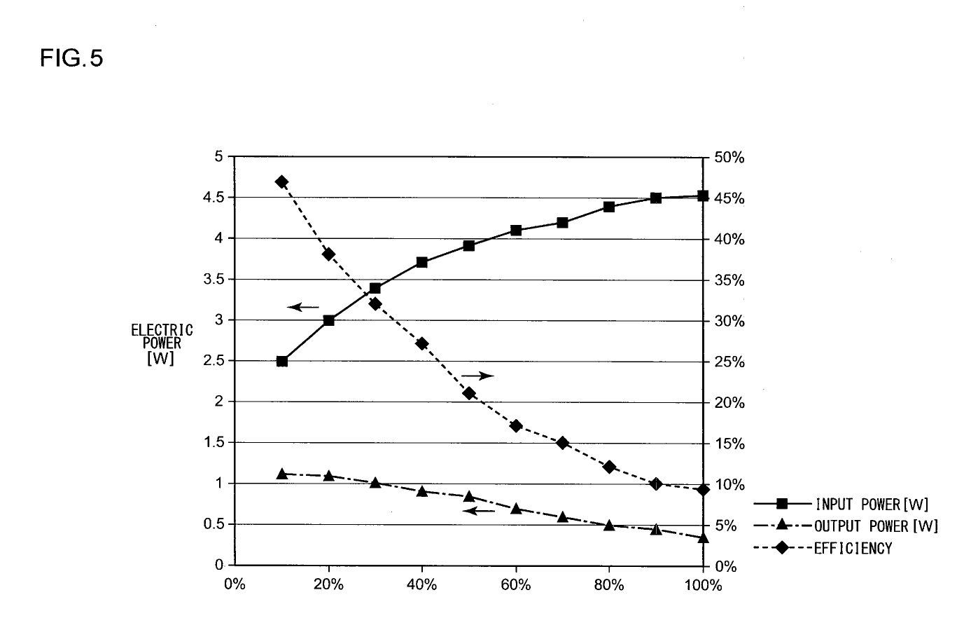

FIG. 5 is a graph showing the relation between the transmitted electric power, the received electric power, and the transmission efficiency, with respect to the duty ratio. The horizontal axis represents the time ratio (%) of the first state φ₁ with respect to the overall switching period of the first state φ₁ and the second state φ₂ together. Here, the operation with a 100% time ratio corresponds to the operation of the conventional system shown in FIG. 1.

As the time ratio of the period in which the load circuit 20 is connected to the resonance circuit 22 is reduced, the effective Q value rises, as a result of which the input electric power transmitted from the wireless power supply apparatus 200 and the output electric power supplied to the load circuit 20 both increase. Specifically, when the time ratio is set to 70%, the transmission efficiency η is improved up to 15%, as compared with the transmission efficiency obtained when the time ratio is set to 100%, which is only 9.4%.

Furthermore, with 50%, 30%, 20%, and 10% reductions in the time ratio, the transmission efficiency η increases to 21%, 32%, 38%, and 47%, respectively.

Depending on the application, by setting the time ratio to be equal to or lower than 70%, such an arrangement allows sufficient electric power to be supplied to the load circuit 20. In a case in which greater electric power is required, the time ratio should be reduced to a value that is equal to or lower than 50%.

The duty ratio of the switching operation may be changed according to the distance between the wireless power supply system 100 and the wireless power supply apparatus 200, the coupling efficiency between them, and so forth. For example, in a case in which there is a sufficiently strong coupling between the wireless power supply system 100 and the wireless power supply apparatus 200, such an arrangement allows sufficient electric power to be supplied to the load circuit 20 even if the transmission efficiency is low. Thus, in this case, the load circuit 20 may be fixedly connected to the resonance circuit 22.

On the other hand, in a case in which there is a large distance between the wireless power supply system 100 and the wireless power supply apparatus 200, or in a case in which there is an obstacle between them, such an arrangement cannot supply sufficient electric power to the load circuit 20. Even in this case, by reducing the time ratio of the first state φ₁, such an arrangement is capable of supplying electric power to the load circuit 20.

It should be noted that, in the second state φ₂, the load circuit 20 is disconnected from the resonance circuit 22. Accordingly, in the second state φ₂, the load circuit 20 cannot receive electric power supplied via the antenna. Thus, as the load circuit 20, only an arrangement configured to be capable of operating using such intermittently supplied electric power can be employed. Also, an arrangement may be made in which the load circuit 20 includes a capacitor having a large capacitance so as to retain such intermittently supplied electric power. Alternatively, an arrangement may be made in which the load circuit 20 mounts a rechargeable battery, and the battery is charged using the electric power thus received.

### Second Embodiment

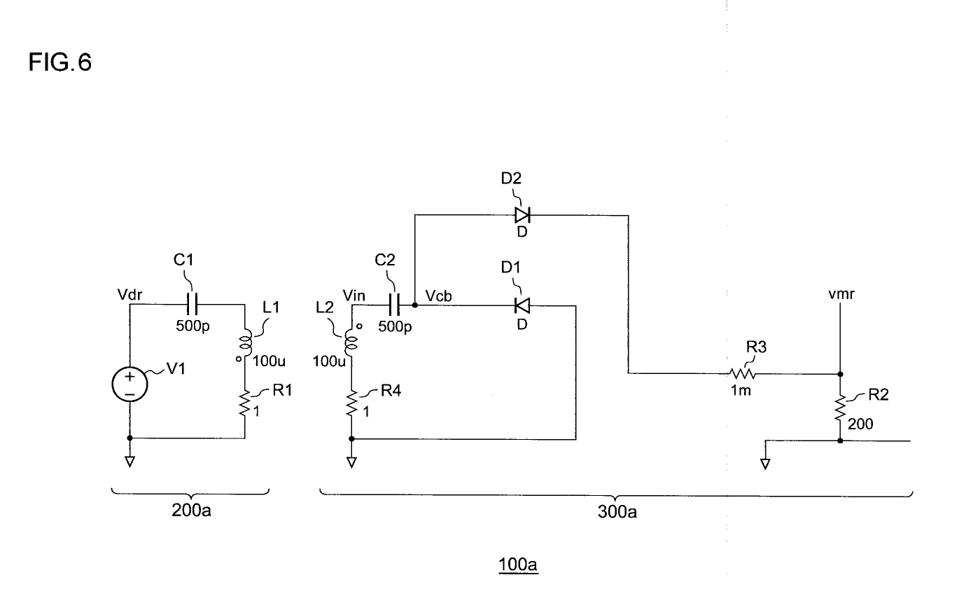

FIG. 6 is a circuit diagram which shows a configuration of a wireless power supply system according to a second embodiment. A wireless power receiving apparatus 300a includes a first diode D1 and a second diode D2, instead of the switch SW1 shown in FIG. 2. The first diode D1 is provided on a loop that comprises the reception coil L2 and the resonance capacitor C1. The second diode D2 is arranged between the cathode of the first diode D1 and the load R2 such that the cathode is arranged on the load R2 side.

With a wireless power supply system 100a shown in FIG. 6, the first diode D1 and the second diode D2 function as a half-wave rectifier circuit, and can be regarded as a switch configured to intermittently couple the load resistor R2 to the resonance circuit.

With a conventional arrangement in which the load R2 is always connected to the resonance circuit, the transmission efficiency is only 10% or less. In contrast, the circuit shown in FIG. 6 provides 13.7% electric transmission efficiency, with 4.25 W of input electric power and 0.56 W of output electric power. As described above, the wireless power receiving apparatus 300a shown in FIG. 6 provides improved transmission efficiency.

While the preferred embodiments of the present invention have been described using specific terms, such description is for illustrative purposes only, and it is to be understood that changes and variations may be made without departing from the spirit or scope of the appended claims.

What is claimed is:

1. A wireless power receiving apparatus configured to receive an electric power signal including any one of an electric field, magnetic field, or electromagnetic field, transmitted from a wireless power supply apparatus, the wireless power receiving apparatus comprising:
a reception coil configured to receive the electric power signal;
a resonance capacitor arranged together with the reception coil to form a resonance circuit;
a load circuit;
a switch configured to switch the state between a first state in which the load circuit is connected in series with the resonance circuit comprising the reception coil and the resonance capacitor and a second state in which the load circuit is disconnected from the resonance circuit; and
a control unit configured to control the switch so as to alternately switch the state between the first state and the second state in a time sharing manner.

2. A wireless power receiving apparatus according to claim 1, wherein the time ratio of the first state is 70% or less of the period of the overall switching operation.

3. A wireless power receiving apparatus according to claim 1, wherein the time ratio of the first state is 50% or less of the period of the overall switching operation.

4. A wireless power receiving apparatus configured to receive an electric power signal including any one of an electric field, magnetic field, or electromagnetic field, transmitted from a wireless power supply apparatus, the wireless power receiving apparatus comprising:
a reception coil configured to receive the electric power signal;
a resonance capacitor arranged together with the reception coil to form a resonance circuit;
a load circuit;
a first diode arranged on a loop that comprises the reception coil and the resonance capacitor; and
a second diode arranged between the cathode of the first diode and the load such that the cathode is arranged on the load side.

5. A wireless power supply system comprising:
a wireless power supply apparatus configured to transmit an electric power signal including any one of an electric field, magnetic field, or electromagnetic field; and
a wireless power receiving apparatus configured to receive the electric power signal, wherein
the wireless power receiving apparatus comprises:
a reception coil configured to receive the electric power signal;
a resonance capacitor arranged together with the reception coil to form a resonance circuit;
a load circuit;
a switch configured to switch the state between a first state in which the load circuit is connected in series with the resonance circuit comprising the reception coil and the resonance capacitor and a second state in which the load circuit is disconnected from the resonance circuit; and
a control unit configured to control the switch so as to alternately switch the state between the first state and the second state in a time sharing manner.

6. A wireless power supply system according to claim 5, wherein the time ratio of the first state is 70% or less of the period of the overall switching operation.

7. A wireless power supply system according to claim 5, wherein the time ratio of the first state is 50% or less of the period of the overall switching operation.

8. A wireless power supply system comprising:
a wireless power supply apparatus configured to transmit an electric power signal including any one of an electric field, magnetic field, or electromagnetic field; and
a wireless power receiving apparatus configured to receive the electric power signal, wherein
the wireless power receiving apparatus comprises:
a reception coil configured to receive the electric power signal;
a resonance capacitor arranged together with the reception coil to form a resonance circuit;
a load circuit;
a first diode arranged on a loop that comprises the reception coil and the resonance capacitor; and
a second diode arranged between the cathode of the first diode and the load such that the cathode is arranged on the load side.
